(19) United States
(12) Patent Application Publication
(10) Pub. No.: US 2004/0078308 A1
(43) Pub. Date: Apr. 22, 2004

(54) Method of supplying metal material for manufacture of sputtering targets and other articles

(76) Inventor: Christopher A. Michaluk, Gilbertsville, PA (US)

Correspondence Address: Martha Ann Finnegan, Esq., Cabot Corporation, 157 Concord Road, Billerica, MA, 01821-7001, US

(21) Appl. No.: 10/274,815

(22) Filed: Oct. 21, 2002

(51) Int. Cl. G06F 17/60

(52) U.S. Cl. 705/34

(57) ABSTRACT

A method of supplying a metal material including supplying from a supplier a quantity of metal material to a sputtering target manufacturer or other user for forming a sputtering target or other metal article from a portion of the quantity of metal material supplied, returning a portion of the supplied material not present in the finished sputtering target or other metal article to the supplier or the supplier's agent, and charging the manufacturer or user only for a portion of the supplied material not returned is described.

### BACKGROUND OF THE INVENTION

The present invention relates to a method of supplying a metal material to a user for forming sputtering targets and other metal articles, and more particularly, to a method of supplying the metal material to a sputtering target manufacturer in which the supplier charges for only the amount of the metal supplied which is retained by the manufacturer.

In industry, fabrication of metal articles typically generates a certain amount of metal that is not included in finished metal articles. To the extent that it is unusable to a metal fabricator, such scrap metal is an undesirable byproduct of manufacturing processes, such that the value lost in downgrading unused material from its purchase price to scrap price can represent a significant portion of the total manufacturing cost that is reflected in the price of finished metalwork. Under the traditional business model, costs associated with scrap metal generation are bore almost entirely by the metal fabricator.

In the sputter application field, the typical supply chain of metal material includes a primary metal processor Macho processes metal ores and raw materials into metals or alloys thereof (or fine metal-containing material such as oxide, nitride, silicide, etc.), typically of a high purity. Refinement of the metal material by such processing produces melt feedstock. As its name suggests, the melt feedstock is then melted or otherwise consolidated by the primary metal processor into forms such as ingots that are then further processed into shapes or mill forms such as billets, rods, plates, or discs. The mill forms are then sold to a sputtering target manufacturer. The target manufacturer then performs additional refinement techniques on the mill forms prior to fabricating the material to produce a finished sputtering target assembly comprising a precision-machined metal target or metal target blank attached to a backing plate.

Hence, the value created by the primary metal processor is, generally, that of converting raw materials into refined metal or melt feedstock, typically of high purity, consolidating the melt feedstock into an ingot, and processing the ingot into mill forms The sputtering target manufacturer creates value by performing additional steps of metal working on the mill forms purchased from the primary metal processor to form a metal target, bonding the metal target onto a backing plate, and machining, polishing, or otherwise surface conditioning the finished sputtering target assembly.

Because salvaged scrap metal can be melted into mill forms and sold to the sputtering target manufacturer, the value of any scrap metal generated during the manufacturing processes performed by the sputtering target manufacturer is equivalent to the value of the melt feedstock. Therefore, the “downgrade” costs of scrap metal generation is equivalent to the total value created by both the primary metal processor and the sputtering target manufacturer between the melt feedstock stage and the particular step in the manufacturing process in which the scrap was created, plus the profit associated with the sale of the mill forms by the primary metal processor to the sputtering target manufacturer. The scrap downgrade costs can represent a significant portion of the sputtering target manufacturer's total manufacturing costs, and are accordingly passed along to its customers in the form of higher prices for the finished product.

In the precious metals industry, and in particular the precious metals sputtering target business, the intrinsic value of the metal atoms are usually significantly greater than the value added by the metal processor in melting and forming the metal product. Furthermore, gold, silver, platinum, and other precious metals are traded on the open market, and the market value of these metals are reported in financial publications such as the Wall Street Journal. Typically, the costs borne by a buyer of a precious metal item is the published value of the metal on the date of sale, plus a nominal fabrication charge of about 5% to cover the processor's manufacturing costs (non inclusive of metal costs) plus the processor's profit. Negating fluctuations in the market price of the precious metal, the downgrade cost of precious metal scrap is the nominal fabrication charge. Precious metal products, including sputtering targets, are often leased; the customer is charged for the material consumed plus the processor's fabrication fee, plus the interest on the value of metal from the date of sale to the date of return.

For materials besides precious metals, significant value is added by the processors in achieving the high purity and other attributes required for use as sputtering targets. The market price for electronics-grade, high purity metals such as titanium, aluminum, and copper can sell for more than 10 times the intrinsic metal value cited by financial resources such as the London Metals Market. Likewise, for less common metals such as high purity tantalum and niobium, whose intrinsic value is not readily publicized to the common market, the spread between metal product selling price and metal scrap price could be substantial. For materials whose market value is disproportionate to its published intrinsic value, or whose intrinsic value is not publicly disclosed, the sales or leasing model used by the precious metals industry is not applicable, and a traditional buy-sell business model is employed: processors sell material to fabricators at the materials market price, and fabricators sell unused material to processors of scrap value.

Accordingly, a need exists for a method of supplying metal material whereby the value lost by the generation of scrap metal in manufacturing processes performed by a metal article fabricator can be significantly reduced.

### SUMMARY OF THE PRESENT INVENTION

It is therefore a feature of the present invention to provide a method of supplying a metal material from a supplier to a sputtering target manufacturer or other user for forming sputtering targets and other metal articles such that the value lost by the generation of scrap metal in manufacturing processes performed by the user are significantly reduced.

It is another feature of the present invention to provide a finished metal article, such as a sputtering target, to a user that consumes a portion of the finished metal article, such that the value lost by the user in reclaiming the remaining “spent” metal is significantly reduced.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention is directed to a method of supplying a metal material to a sputtering target manufacturer or other user for use in forming sputtering targets or other metal articles, returning a portion of the metal material which is not included in the metal articles so formed to the supplier or agent thereof, and charging the user for a portion of the metal material supplied which is not returned to the supplier or agent thereof.

In one embodiment of the present invention, the method includes charging the user a fee for the portion of the metal material that is returned by the user.

In another embodiment of the present invention, the metal material comprises a valve metal, including tantalum, niobium, and alloys thereof

In another embodiment of the present invention, the metal material comprises high purity titanium, aluminum, or copper.

In another embodiment of the present invention, supplying the metal material to the user comprises a bailment.

In another embodiment of the present invention, the step of charging the user occurs at regular time intervals.

In yet another embodiment of the present invention, the step of charging the user occurs after each return of metal material by the user.

In another embodiment of the present invention, the user is charged an interest fee on the value of the material during the time period it is retained by the user.

It is to be understood that both the foregoing general description and the following detailed description are exemplary and explanatory only and are intended to provide a further explanation of the present invention, as claimed.

### BRIEF DESCRIPTION OF THE DRAWINGS

FIGS. 1 and 2 are block diagrams. FIG. 1 shows the various steps in a traditional processing and supplying of tantalum and FIG. 2 shows an embodiment of the present invention.

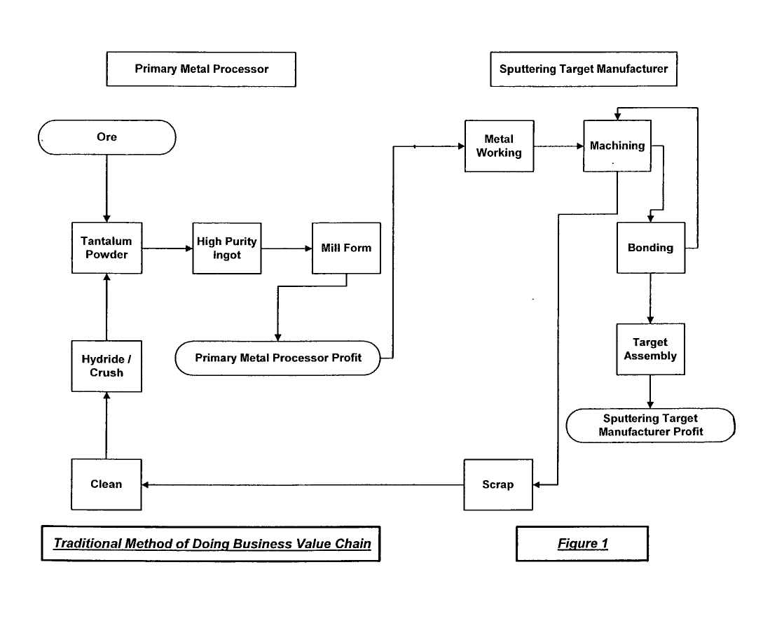

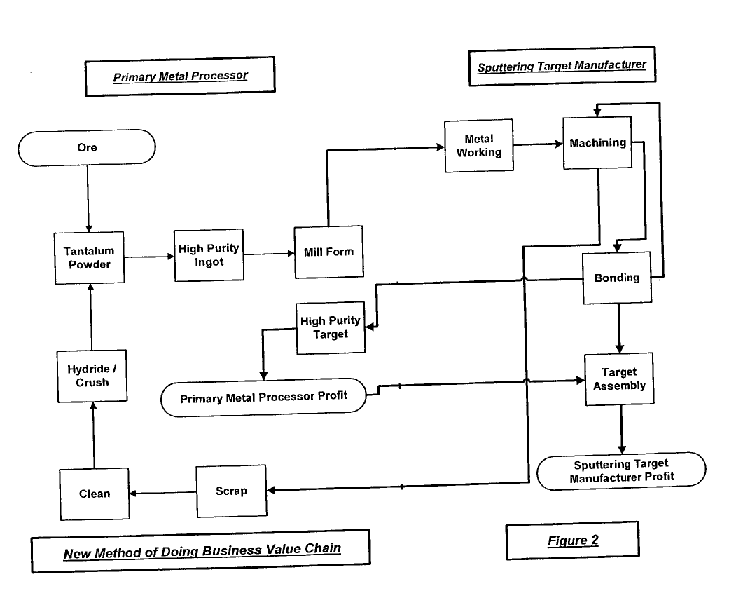

### DETAILED DESCRIPTION OF THE PRESENT INVENTION

The present invention is directed to a method of supplying a metal material, the metal material including valve metals such as tantalum, niobium, and alloys thereof, to a user for manufacture of sputtering targets and other metal articles. A method according to the present invention of supplying a metal material includes supplying from a supplier a quantity of metal material to a user for forming metal articles from a portion of the metal supplied; returning a portion of the metal supplied which is not present in the metal articles formed to the supplier or an agent of the supplier; and charging the user only for that portion of the metal material supplied which is not returned to the supplier or the agent of the supplier. The method can further include charging the user a fee for returning a portion of the metal material supplied. The method can also include charging interest on the value of material from the time the material is provided to the user to the time the customer is invoiced for the material that is consumed.

As to supplying from a supplier a quantity of metal material to a user, the metal material can be any non-precious metal and is preferably a valve metal which generally includes tantalum, niobium, and alloys thereof, and also may include metals of Groups IVB, VB, and VIB, and aluminum and copper, and alloys thereof. Valve metals are described, for example, by Diggle, in “Oxides and Oxide Films,” Vol. 1, pp. 94-95, 1972, Marcel Dekker, Inc., New York, incorporated in its entirety by reference herein. Valve metals are generally extracted from their ores and formed into powders by processes that include chemical reduction, as described for example, in U.S. Pat. No. 6,348,113 (Michaluk et al.), which is incorporated in its entirety by reference herein, by a primary metal processor. Further metal refining techniques typically performed by a primary metal processor include thermally agglomerating the metal powder, deoxidizing the agglomerated metal powder in the presence of a getter material, and then leaching the deoxidized metal powder in an acid leached solution, as disclosed, for example, in U.S. Pat. No. 6,312,642 (Fife), which is incorporated in its entirety by reference herein. A primary metal processor typically then subjects the valve metal powder or melt feedstock to an electron beam or to vacuum arc melting or other melting technique to form a metal ingot. The primary metal processor then further processes the valve metal ingot into mill forms such as billets, rods, plates, or discs which are suitable for sputtering target manufacture. In the alternative, the metal material can be a powder metallurgical product Thus, the supplier according to the present invention can be a primary metal processor.

Preferably, the metal material is any metal that can be sputtered or eroded in a sputtering or deposition process. More preferably, the metal material is a high purity metal product whose market value is significantly greater than the intrinsic value of the metal, or whose intrinsic market value is not publicly disclosed. Most preferably, the metal material is a valve material such as tantalum or niobium or alloys thereof. Other examples of suitable materials include, but are not limited to, cobalt, titanium, aluminum, copper, tungsten and alloys thereof. Other examples include Ta—W alloys, Ta—Nb alloys, Ta—Mo alloys, Ta—Ti alloys, Ta—Zn alloys, Nb—W alloys, Nb—Ta alloys, Nb—Mo alloys, Nb—Ti alloys, Nb—Hf alloys, Nb—Zr alloys, W, Re, Hf, Mo, V, Cr, Be, In, Sn, Ir, Nd, Ce, Yb, Am, Cm, No, or alloys thereof. The metal material can also be oxides, carbides, and nitrides of the above-mentioned materials. The metal material can also be organic or inorganic chemical compositions comprising the metal, such as precursors for Chemical Vapor Deposition (CVD) or Atomic Layer Deposition (ALD).

The user to which the quantity of metal material is supplied can be any metal fabricator. Preferably, the user is a sputtering target manufacturer or sub-contractor thereof The metal materials supplied can be used to form any metal article. Preferably, the metal material is used to form a sputtering target. For purposes of the present invention, the sputtering target can be an intermediate product form that is further processed by the user or subcontractor, into a near-net shape or net-shape sputtering target blank or form, or can be the sputtering target bonded onto a backing plate. The sputtering target and the backing plate can be any suitable target grade and backing plate grade materials. For instance, the sputtering target blank can be tantalum or niobium or alloys thereof. No limitation exists as to the type of materials used in the sputtering target. Furthermore, the formation of the target and the backing plate can be of any suitable formation and again, the formation of the target and the bonding of the backing plate onto the target, is not critical to the present invention. The sputtering target can also have an interlayer as is conventional in the industry. Furthermore, the sputtering target can be a hollow cathode magnetron sputtering target and can be other forms of sputtering targets. The purity, texture, and/or grain size and other parameters, including size and the like are not critical to the present invention The present invention provides a method to supply metal material to a user for forming any type of sputtering target and other metal articles.

An embodiment of the present invention involves a method of doing business which includes providing metal material to a fabricator where the metal material is used in sputtering target manufacture. The sputtering target manufacturer creates value by conducting additional metal working operations, bonding the resulting metal onto a backing plate, and machining the finished sputtering target assembly which also results in the formation of scrap metal The amount of metal material contained in the finished sputtering target assembly can be determined and then the fabricator or customer or the individual being charged can be charged for the amount of the metal material that is retained. The method further includes the returning of the scrap metal to the supplier or to an agent of the supplier. The fabricator is only charged for the actual amount of metal material included in the sputtering target assemblies and/or not returned to the supplier, and any other additional charges that are part of the service. That is, the metal material sold by the supplier to the user is the unreturned portion of the metal material initially supplied.

The process is beneficial to the primary metal processor because it helps to assure that scrap metal is returned for reprocessing. Returning the scrap metal for reprocessing reduces the need to mine and refine or to replace the amount of metal material that would be discarded scrap metal. Furthermore, the method serves as a quality control process by controlling the introduction of undesirable impurities in the scrap metal that is ultimately reprocessed by the primary metal processor into mill forms suitable for sputtering target manufacture. Put another way, when the unused metal is returned to the metal supplier, the supplier immediately knows the quality of the returned metal.

The fabricator benefits from the above practice since, typically in the business, scrap metal is an undesirable byproduct of the sputtering target manufacture process which causes loss of revenue to the fabricator. According to the method of the present invention, the scrap downgrade cost is reduced. As discussed above, scrap downgrade is equivalent to the total value created by both the primary metal processor and the sputtering target manufacturer between the melt feedstock or similar stage and the particular step in the manufacturing process in which the scrap was created, plus the profit associated with the sale of the mill forms by the primary metal processor to the sputtering target manufacturer. The method provides that the fabricator is charged for neither the value created by the primary metal processor to the melt feedstock to the point of supplying the mill forms to the manufacturer, nor the associated profit therefrom. Another benefit of this method of doing business is that the overall manufacturing cost of the sputtering target manufacturer is additionally reduced since the sputtering target manufacturer is charged only for the metal material retained or used for assembling the finished sputtering target assembly. Therefore, the sputtering target manufacturer is charged for less metal material than it would be by the traditional business model.

Optionally, the user of the metal material can be charged a fee for returning a portion of the quantity of metal material supplied. Such a fee can reflect costs associated with the return of the material, including packaging, shipping, storage, rent, and other handling.

In another embodiment of the present invention, the method of supplying a metal material to a user can comprise a bailment in which the supplier is the bailor and the user is the bailee, and the quantity of metal material supplied is the bailed goods. In this embodiment, there is no transfer of ownership of the material supplied until the point at which it is determined what portion of the metal material supplied is retained in the metal articles formed by the user.

In one embodiment of the present invention, the user is charged according to the present invention after each return of a portion of the quantity of material supplied. In another embodiment, the user is charged according to the present invention at regular time intervals. In another embodiment, the user is charged interest on the value of the material from the time the material is provided to the user to the time the user is invoiced or other defined period of time. Any means to track and determine the amount used and/or the amount returned can be used. A computer program can be used to track and determine costs. Bar codes or other tracking devices can be associated with each shipment to the manufacturer and then a bar code or other tracking device can be returned in order to know what shipment is being returned unused. With the present invention, each individual shipment and use can be tracked and billed or multiple shipments and/or multiple returns can be combined into a single bill. Any combination can be used.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of supplying a non precious metal material comprising:
(a) supplying from a supplier a quantity of non precious metal material to a sputtering target manufacturer, wherein said manufacturer forms at least one sputtering target from a portion of said quantity;
(b) returning a portion of said quantity not present in said at least one sputtering target to said supplier or agent thereof; and
(c) charging said manufacturer only for a portion of said quantity not returned to said supplier or agent thereof.

2. The method of claim 1, further comprising charging said manufacturer a fee for returning said portion of said quantity.

3. The method of claim 1, further comprising charging said manufacturer interest on the non precious metal provided from the time the material is provided to the user to the time the user is invoiced or other defined period of time.

4. The method of claim 1, wherein the metal material comprises a valve metal.

5. The method of claim 1, wherein the valve metal comprises tantalum.

6. The method of claim 1, wherein the valve metal comprises niobium.

7. The method of claim 1, wherein the valve metal comprises titanium.

8. The method of claim 1, wherein the metal material comprises copper.

9. The method of claim 1, wherein the metal material comprises aluminum

10. The method of claim 1, wherein the metal material comprises a mill form.

11. The method of claim 1, wherein said supplier is a primary metal processor.

12. The method of claim 1, wherein supplying from a supplier a quantity of metal material comprises a bailment.

13. The method of claim 12, wherein title to said portion of said quantity not returned remains with said supplier.

14. The method of claim 1, wherein said step (c) occurs at regular time intervals.

15. The method of claim 1, wherein said step (c) occurs after each return of said portion of said quantity.

16. A method of supplying a non precious metal material comprising:
a) supplying from a supplier a quantity of non precious metal material to a user, wherein said user forms at least one metal article from a portion of said quantity;
b) returning a portion of said quantity not present in said at least one metal article to said supplier or agent thereof; and
c) charging said user only for a portion of said quantity not returned to said supplier or agent thereof, and optionally.
d) charging said user interest on the non precious metal provided from the time the material is provided to the user to the time the user is invoiced or other defined period of time.
